(19) United States
(12) Patent Application Publication
(10) Pub. No.: US 2026/0046949 A1
(43) Pub. Date: Feb. 12, 2026

(54) NON-INTEGRATED ACCESS PROTOCOL DATA UNIT SESSION MANAGEMENT

(71) Applicant: QUALCOMM Incorporated, San Diego, CA (US)

(72) Inventors: Juan ZHANG, San Diego, CA (US); Ajith Tom PAYYAPPILLY, San Diego, CA (US)

(21) Appl. No.: 18/796,019

(22) Filed: Aug. 6, 2024

(51) Int. Cl. H04W 76/12; H04L 12/46; H04W 12/041; H04W 12/06

(52) U.S. Cl. CPC H04W 76/12; H04L 12/4633; H04W 12/041; H04W 12/06

(57) ABSTRACT

Methods, systems, and devices for wireless communications are described. A network entity (e.g., a user equipment (UE)) may establish, via a first radio access technology (RAT), a secure tunnel between the network entity and a user plane function (UPF) of a core network associated with a second RAT that is different from the first RAT. The network entity may perform, via the secure tunnel, an authentication and key establishment procedure with the UPF to obtain a key. The network entity may establish one or more protocol data unit (PDU) sessions with the UPF. The network entity may communicate, using the key, data communications with the core network via the UPF and via the one or more PDU sessions.

### INTRODUCTION

The following relates to wireless communications, including non-integrated access protocol data unit session management.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications performed by a network entity is described. The method may include establishing, via a first radio access technology (RAT), a secure tunnel between the network entity and a user plane function (UPF) of a core network associated with a second RAT that is different from the first RAT, performing, via the secure tunnel, an authentication and key establishment procedure with the UPF to obtain a key, establishing one or more protocol data unit (PDU) sessions with the UPF, and communicating, using the key, data communications with the core network via the UPF and via the one or more PDU sessions.

A network entity for wireless communications performed is described. The network entity may include a processing system configured to establish, via a first RAT, a secure tunnel between the network entity and a UPF of a core network associated with a second RAT that is different from the first RAT, perform, via the secure tunnel, an authentication and key establishment procedure with the UPF to obtain a key, establish one or more PDU sessions with the UPF, and communicate, using the key, data communications with the core network via the UPF and via the one or more PDU sessions.

Another network entity for wireless communications performed is described. The network entity may include means for establishing, via a first RAT, a secure tunnel between the network entity and a UPF of a core network associated with a second RAT that is different from the first RAT, means for performing, via the secure tunnel, an authentication and key establishment procedure with the UPF to obtain a key, means for establishing one or more PDU sessions with the UPF, and means for communicating, using the key, data communications with the core network via the UPF and via the one or more PDU sessions.

A non-transitory computer-readable medium having code for wireless communications stored thereon that, when executed by a network entity, causes the network entity to establish, via a first RAT, a secure tunnel between the network entity and a UPF of a core network associated with a second RAT that is different from the first RAT, perform, via the secure tunnel, an authentication and key establishment procedure with the UPF to obtain a key, establish one or more PDU sessions with the UPF, and communicate, using the key, data communications with the core network via the UPF and via the one or more PDU sessions.

Some examples of the method, network entities, and non-transitory computer-readable medium described herein may further include operations, features, means, or instructions for encapsulating, based on support for functionality associated with the one or more PDU sessions, at least one data communication of the data communications, where the functionality includes a steering functionality, a switching functionality, or a splitting functionality.

Some examples of the method, network entities, and non-transitory computer-readable medium described herein may further include operations, features, means, or instructions for encapsulating the data communications includes encapsulating the data communications using a type of encapsulation and the type of encapsulation includes either a multi-path-quick user datagram protocol (UDP) internet communication (MPQUIC)-based encapsulation or a multi-path transport control protocol (MPTCP)-based encapsulation.

Some examples of the method, network entities, and non-transitory computer-readable medium described herein may further include operations, features, means, or instructions for encapsulating the data communications includes encapsulating the data communications using a type of encapsulation, the type of encapsulation includes either a MPQUIC-based encapsulation or a MPTCP-based encapsulation, and the data communications include internet protocol (IP)-based communications using either the MPQUIC-based encapsulation or the MPTCP-based encapsulation.

Some examples of the method, network entities, and non-transitory computer-readable medium described herein may further include operations, features, means, or instructions for encapsulating, based on non-support for a functionality associated with the one or more PDU sessions, at least one data communication of the data communications, where the functionality includes a steering functionality, a switching functionality, or a splitting functionality.

Some examples of the method, network entities, and non-transitory computer-readable medium described herein may further include operations, features, means, or instructions for encapsulating the data communications includes encapsulating the data communications using a type of encapsulation and the type of encapsulation includes a point-to-point (PTP)-vendor specific network protocol (VSNP) IP header-level encapsulation.

In some examples of the method, network entities, and non-transitory computer-readable medium described herein, one or more fields associated with a PTP-VSNP IP header used in the PTP-VSNP IP header-level encapsulation indicate at least one of a PDU session identifier, a data network name (DNN), or identify the one or more PDU sessions.

Some examples of the method, network entities, and non-transitory computer-readable medium described herein may further include operations, features, means, or instructions for encapsulating the data communications includes encapsulating the data communications using a type of encapsulation, the type of encapsulation includes an IP header-level encapsulation, and the data communications include internet messaging service (IMS) or voice-over WiFi (VoWiFi) communications.

Some examples of the method, network entities, and non-transitory computer-readable medium described herein may further include operations, features, means, or instructions for encapsulating the data communications includes encapsulating the data communications using a type of encapsulation and the type of encapsulation excludes a MPQUIC-based encapsulation and a MPTCP-based encapsulation.

Some examples of the method, network entities, and non-transitory computer-readable medium described herein may further include operations, features, means, or instructions for establishing the secure tunnel includes establishing the secure tunnel using a point-to-point-link control protocol (PTP-LCP).

In some examples of the method, network entities, and non-transitory computer-readable medium described herein, the first RAT includes a non-cellular RAT and the second RAT includes a cellular RAT.

In some examples of the method, network entities, and non-transitory computer-readable medium described herein, the secure tunnel may be associated with a non-integrated non-third generation partnership project (3GPP) access PDU session management procedure.

Some examples of the method, network entities, and non-transitory computer-readable medium described herein may further include operations, features, means, or instructions for establishing the secure tunnel includes establishing the secure tunnel using a type of protocol and the type of protocol includes a transport control protocol (TCP)-transport layer security (TLS) protocol.

Some examples of the method, network entities, and non-transitory computer-readable medium described herein may further include operations, features, means, or instructions for terminating a TCP-TLS session established using the TCP-TLS protocol upon establishment of the one or more PDU sessions.

In some examples of the method, network entities, and non-transitory computer-readable medium described herein, the one or more PDU sessions may be in accordance with a dynamic host configuration protocol (DHCP) discover message, the DHCP discover message identifies a data network name (DNN), and the DHCP discover message identifies the one or more PDU sessions.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports non-integrated access protocol data unit (PDU) session management in accordance with one or more aspects of the present disclosure.

FIG. 2 shows an example of a wireless communications system that supports non-integrated access PDU session management in accordance with one or more aspects of the present disclosure.

FIG. 3 shows an example of a swim diagram that supports non-integrated access PDU session management in accordance with one or more aspects of the present disclosure.

FIG. 4 shows an example of a swim diagram that supports non-integrated access PDU session management in accordance with one or more aspects of the present disclosure.

FIGS. 5 and 6 show block diagrams of devices that support non-integrated access PDU session management in accordance with one or more aspects of the present disclosure.

FIG. 7 shows a block diagram of a communications manager that supports non-integrated access PDU session management in accordance with one or more aspects of the present disclosure.

FIG. 8 shows a diagram of a system including a device that supports non-integrated access PDU session management in accordance with one or more aspects of the present disclosure.

FIGS. 9 through 11 show flowcharts illustrating methods that support non-integrated access PDU session management in accordance with one or more aspects of the present disclosure.

### DETAILED DESCRIPTION

Wireless networks may support access traffic steering, switching, and splitting (ATSSS) functionality via a non-third generation partnership project (3GPP) wireless network for user equipment (UE) access. For example, such networks may support multiple-access ATSSS functionality using transport control protocol (TCP), multi-path user datagram protocol (UDP) internet communications (MPQUIC), or lower layer (LL) techniques. However, such techniques are associated with various shortcomings or deficiencies. For example, some techniques may not support multiple protocol data unit (PDU) sessions. As another example, some techniques are associated with significant overhead increases, such as due to encapsulation of packets.

Accordingly, aspects of the described techniques provide for a non-integrated access PDU session management via a non-3GPP wireless network. For example, a UE may establish a secure tunnel with a user plane function (UPF) of a core network. The secure tunnel may be established via a first radio access technology (RAT), such as a non-3GPP network, that is different from a second RAT associated with the core network, such as a 3GPP network core network function. The UE may perform an authentication and key exchange procedure via the secure tunnel to identify or otherwise obtain a key (e.g., a security key). The UE may establish one or more (e.g., a plurality of) PDU sessions with the UPF. The UE may perform data communications with the core network via the UPF using the plurality of PDU sessions. The data communications maybe performed in accordance with the authentication and key exchange (e.g., using the key).

Aspects of the disclosure are initially described in the context of wireless communications systems. Aspects of the disclosure are further illustrated by and described with reference to apparatus diagrams, system diagrams, and flowcharts that relate to non-integrated access PDU session management.

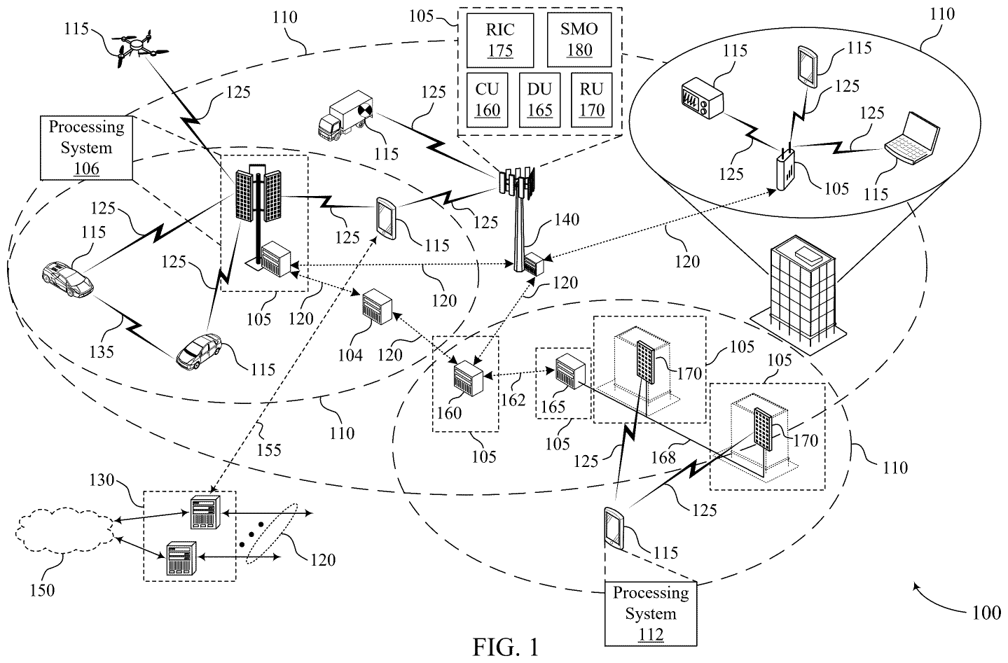

FIG. 1 shows an example of a wireless communications system 100 that supports non-integrated access PDU session management in accordance with one or more aspects of the present disclosure. The wireless communications system 100 may include one or more devices, such as one or more network devices (e.g., network entities 105), one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some aspects, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (cRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some aspects, the first communication interface may be an interface configured to receive input information, and the information may be provided to the processing system. In some aspects, the second system interface may be configured to transmit information output from the chip or modem. The second communication interface may also obtain or receive input information, and the first communication interface may also output, transmit, or provide information.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some aspects, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some aspects, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some aspects, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some aspects, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some aspects, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHZ)). Devices of the wireless communications system 100 (e.g., the network entities 105, the UEs 115, or both) may have hardware configurations that support communications using a particular carrier bandwidth or may be configurable to support communications using one of a set of carrier bandwidths. In some aspects, the wireless communications system 100 may include network entities 105 or UEs 115 that support concurrent communications using carriers associated with multiple carrier bandwidths. In some aspects, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some aspects, a UE 115 may be configured with multiple BWPs. In some aspects, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some aspects, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some aspects, a carrier may support multiple cells, and different cells may be configured according to different protocol types (e.g., MTC, narrowband IoT (NB-IoT), enhanced mobile broadband (eMBB)) that may provide access for different types of devices.

In some aspects, a network entity 105 (e.g., a base station 140, an RU 170) may be movable and therefore provide communication coverage for a moving coverage area, such as the coverage area 110. In some aspects, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some aspects, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some aspects, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some aspects, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to one or more of the UEs 115 in the group. In some aspects, a network entity 105 may facilitate the scheduling of resources for D2D communications. In some other aspects, D2D communications may be carried out between the UEs 115 without an involvement of a network entity 105.

In some systems, a D2D communication link 135 may be an example of a communication channel, such as a sidelink communication channel, between vehicles (e.g., UEs 115). In some aspects, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some aspects, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some aspects, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some aspects, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some aspects, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some aspects, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some aspects, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some aspects, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 (e.g., which may be referred to as a network entity in this example) may establish, via a first RAT, a secure tunnel between the network entity and a UPF of a core network associated with a second RAT that is different from the first RAT. The UE 115 may perform, via the secure tunnel, an authentication and key establishment procedure with the UPF to obtain a key. The UE 115 may establish one or more PDU sessions with the UPF. The UE 115 may communicate, using the key, data communications with the core network via the UPF and via the one or more PDU sessions.

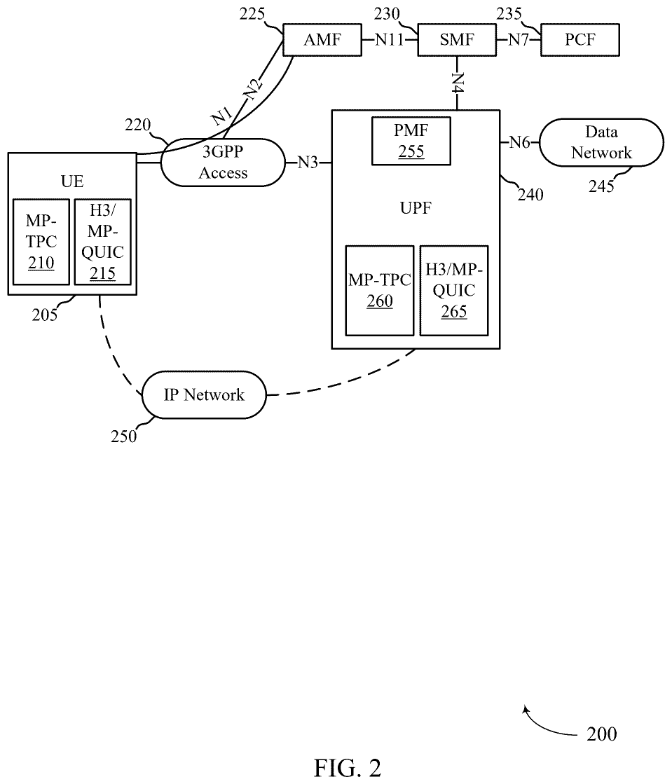

FIG. 2 shows an example of a wireless communications system 200 that supports non-integrated access PDU session management in accordance with one or more aspects of the present disclosure. Wireless communications system 200 may implement aspects of wireless communications system 100. Wireless communications system 200 may include a UE 205 and a network entity 220, which may be examples of the corresponding devices described herein.

Wireless networks may support various ATSSS functionality where a UE may access cellular services via a 3GPP access or wireless link as well as, or instead of, a non-3GPP access or wireless link. The steering functionality may include the possibility of selecting the best link to use for user plane traffic based on the service (e.g., the quality of service (QoS)) for a data flow. The switching may include the possibility of performing handover without service interruption to the other link, when necessary. The splitting may include the simultaneous use (e.g., bonding) of multiple links.

Some wireless networks may support different types of configurations of such ATSSS functionality. For example, some wireless networks may support ATSSS-MPTCP functionality, ATSSS-MPQUIC functionality, or ATSSS-LL functionality. Each of these functionalities may be associated with its own advantages and disadvantages and the network operator may choose to deploy one or more of the functions depending on the various steering, switching, or splitting modes that are optimal for the specific network. In some aspects, each functionality may be based on a non-3GPP inter-working function (N3IWF) network function or an evolved packet data gateway (EPDG) (e.g., untrusted accesses) in the non-3GPP leg of the path between the UE and the UPF.

However, such functionality is associated with various problems. One problem may include the IP security (IPSec) causing too much of a load on the EPDG/N3IWF link if it is used for internet traffic as opposed to only internet messaging service (IMS) traffic. In some deployments, the non-3GPP access may be used mainly for IMS voice over WiFi (VoWifi), and some other related IMS services. The traffic load may be manageable for operators in this scenario. In some cases, the vast majority of a user's traffic may include the internet traffic going via a local breakout to the Wifi network without operator involvement. One of the goals of ATSSS is to bring some of that internet traffic to the operator's core network. However, ATSSS having not been commercially deployed may be one of the main reasons contributing to the load problem due to the presence of IPSec on the EPDG/N3IWF link.

Another problem with N3IWF (though not present for EPDG) is the non-access stratum (NAS) signaling necessary over the non-3GPP access. This makes implementations complex and there is lot of reluctance to move from EPDG to N3IWF. A third problem for VoWifi traffic may include the encapsulation using MPTCP or MPQUIC that includes too much overhead and a waste of capacity as the actual voice packet is such a small payload but there are various encapsulation headers needed using MPTCP or MPQUIC encapsulation. Therefore, the practical option among the three steering modes is ATSSS-LL. However, ATSSS-LL has other drawbacks (such as not supporting re-ordering) which makes it impractical for other traffic.

To overcome such problems, some wireless networks may define a lite version of ATSS (ATSSS-Lite) that does not use EPDG/N3IWF in the non-3GPPP path between the UE and the UPF. Such functionality may include, when there is a 3GPP access available to the UE, all the signaling happening over the 3GPP access and this signaling controlling both the 3GPP access and the non-3GPP access. When there is no 3GPP access necessary (or available) for the UE, a mode called non-integrated non-3GPP access (NIN3A) may be used. Different signaling options may be used in this example. One signaling option may include the signaling being extended from the 3GPP access available option and there being a timer established at the UE and the network by which the NIN3A-only session is valid even if the 3GPP access goes away or is released by the UE. Before the timer expires, the UE may re-establish the 3GPP access and can renew the NIN3A-only access for a further period of time. Another signaling option may include the signaling and data transfer using the MP-QUIC/MP-TCP encapsulation between the UE and the UPF, with extensible authentication protocol-authenticated key agreement (EAP-AKA) protocol being used for authentication.

However, this approach also suffers from various issues. One problem may include that, although ATSSS-Lite and NIN3A solve the first and second problems discussed above regarding classic ATSSS, they do not address the third problem. For example, this approach still depends on MPQUIC/MPTCP encapsulation of the packets and the resulting overhead of multiple headers for a relatively small payload of voice packets (e.g., wastes capacity). Another problem may include a lack of support for multiple PDU sessions. So, if the network operator uses it to perform steering, switching, or splitting of the internet PDU, it cannot use it for IMS PDU (e.g., VoWiFi), or vice versa. Another issue may relate to a lack of motivation for a network operator to deploy ATSSS-Lite. To support their existing use case of IMS-based VoWiFi, the network operator still needs to deploy the EPDG/N3IWF due to the above-described issues. Therefore, the motivation is for the network operator to use the classic ATSSS for everything. Although deploying both ATSSS and ATSSS-Lite may alleviate some of these issues and reduce the load on EPDG/N3IWF as it continues to only service VoWiFi traffic for internet traffic. However, this two-solution deployment is more complex and logistically unlikely to be adopted by network operators.

Accordingly, aspects of the techniques described herein provide for a NIN3A-only solution that operates without dependence or assumption that the 3GPP access is always present or in its absence. The NIN3A-only session may exist temporarily. There may be independent signaling authentication, for example, on the non-3GPP access. The techniques described herein provide for or otherwise support the steering, switching, and splitting sessions, when required (e.g., on an as-needed basis). At the same time, the described techniques for the NIN3A-only solution are acceptable for stand-alone IMS-based VoWiFi, which is the most common use case for the non-3GPP access in deployed networks. In some aspects, the NIN3A-only techniques described herein may allow for multiple PDU sessions (e.g., IMS, internet, etc.). In some aspects, the NIN3A-only techniques described herein may not add extensive overhead in terms of headers for VoWiFi or other stand-alone use cases.

In some aspects, it is not the case that in order to support a stand-alone use case (e.g., VoWiFi), the solution requires the steering-switching-splitting (SSS) modes. That is, there is difference between both the stand-alone and SSS should be possible to coexist versus the stand-alone use case needs SSS. For classis ATSSS and VoWiFi it was that both stand-alone use case and SSS should be possible to coexist. But for ATSSS-Lite, some networks lean toward the stand-alone use case needing SSS. However, aspects of the techniques described herein change that to each leg of the 3GPP and the non-3GPP accesses may exist in a stand-alone manner. If these legs need to be joined for the purpose of SSS, a MA-PDU session may be established for this purpose.

For example, the UE 205 may establish a connection with a core network via a 3GPP access (e.g., via the network entity 220) and via a non-3GPP access (e.g., via an IP network 250). Each available access may include various RAN or other network functions that may be operably or communicatively coupled within a core network or across different core networks to communicate data with the UE 205. For example, the first access may include a cellular-based access (e.g., a 3GPP access) providing RAN functionality between the UE 205 and the network. The cellular-based access may be a wireless access where the UE 205 communicates over a wireless medium to one or more network entities, cells, or other RAN components (e.g., the network entity 220) of a wireless network, such as over an N1 interface.

The cellular-based access may be operably or communicatively coupled with one or more network functions that manage aspects of wireless communications or data traffic between the network and the UE 205. For example, the cellular-based access (e.g., the network entity 220) may have an N2 interface with an AMF 225. The AMF 225 may manage aspects of wireless access for the UE 205, such as registration, mobility, authentication/security, and other functionality. The AMF 225 may also manage aspects of message transport and routing (e.g., aspects of PDU session management) during a data session for the 3GPP access. The AMF 225 may be operably or communicatively coupled with an SMF 230, such as over an N11 interface. In some aspects, the AMF 225 may manage aspects of selecting an appropriate SMF during a PDU session establishment. The SMF 230 may manage aspects of a decoupled data plane, such as management of managing (e.g., creating, updating, and removing) PDU sessions, as well as the PDU session context, with the UPF 240.

The SMF 230 may be operably or communicatively coupled with a PCF 235, such as via an N7 interface. The PCF 235 may manage aspects of user plane resources for a data session, such as establishing policies or rules to be applied to the other components. For example, the PCF 235 may provide a unified policy framework governing network behavior. The SMF 230 may also be operably or communicatively coupled with the UPF 240, such as via an N4 interface. The UPF 240 may manage aspects of packet inspection and routing, serve as an anchor point for mobility (in some aspects), enforce policy rules (such as traffic steering rules), among other functionalities. For example, the UPF 240 may be operably or communicatively coupled with the data network 245, such as via an N6 interface. The data network 245 may generally be, in this example, the end-user that is communicating data with the UE 205. The UPF 240 may include a performance measurement function (PMF) entity 255 that uses the PMF protocol (PMFP). The PMF entity 255 may generally provide real-time metrics at the UE 205 and the UPF 240 that may be used to enforce low-level local traffic management based on the status of each link.

The second access may include a non-cellular-based access (e.g., a non-3GPP access via the IP network 250). In some aspects, the UE 205 may be operably or communicatively coupled with the UPF 240 via the non-3GPP access (e.g., via the IP network 250). For example, the UE 205 may include a MP-TPC entity 210 and a H3/MP-QUIC entity 215, which may be operatively coupled with a corresponding MP-TPC entity 260 and H3/MP-QUIC entity 265, respectively, of the UPF 240. For example, the MP-TPC and H3/MP-QUIC entities established or otherwise operating at the UE 205 and the UPF 240 may be logical entities that exchange various information being communicated between the UE 205 and the network via the non-3GPP access, such as supporting various encapsulation and recovery features exchanged via the non-3GPP access.

Accordingly, in some aspects the UE 205 may establish, form, or otherwise enable a secure tunnel between the UE 205 (e.g., which may be referred to as a network entity in this example) and the UPF 240 of a core network associated with a second RAT. The UE 205 may establish the secure tunnel with the UPF 240 via a first RAT (e.g., a non-3GPP RAT) that is different from a second RAT associated with the core network (e.g., a 3GPP RAT associated with the cellular core network that includes the UPF 240). In some aspects, the secure tunnel may be associated with or otherwise correspond to a NIN3A access PDU session management procedure, such as a NIN3A-only access.

The UE 205 may perform an authentication and key establishment procedure with the UPF 240 to obtain a key. The authentication and key establishment procedure may be performed via the secure tunnel (e.g., via the non-3GPP access, such as via the IP network 250). The UE may establish PDU session(s) with the UPF 240 and use the key to communicate data communications with the core network via the UPF 240 and via the PDU session(s). In some aspects, the IKE negotiation stage may specify a NULL encryption to reduce the load of the EPDG/N3IWF (when used) because there is encryption at the TLS level for MPQUIC when SSS functionality is needed for a MA-PDU session.

Thus, at this point the UE 205 may perform wireless communications with the 3GPP core network via the non-3GPP access using the NIN3A-only access functionality. The data being communicated to the core network may have little or no encapsulation. For example, the UE 205 may encapsulate some or all of the data communications based on a lack of or non-support for a functionality. The functionality, in this example, may correspond to any of the steering functionality, the switching functionality, or the splitting functionality. In some cases, such encapsulation of some or all of the data communications may be based on a type of encapsulation, such as a point-to-point-vendor specific network protocol (PTP-VSNP) IP header-level encapsulation. For example, the field(s) of the PTP-VSNP IP header-level may carry or otherwise convey an indication of a PDU session identifier, a data network name (DNN), or other information identify the PDU session(s).

In some example, the UE 205 may use an IP header-level encapsulation to encapsulate some or all of the data communications at this stage. For example, the UE 205 may use the IP header-level encapsulation to encapsulate IMS or VoWiFi traffic being communicated to the UPF 240. Thus, at this stage the UE 205 may use the NIN3A-only access via the IP network 250 to perform data communications with the UPF 240 of the 3GPP core network. This access may provide for such data communications with little encapsulation to reduce or minimize the overhead associated with the data communications. At this stage, the NIN3A-only access may not support SSS functionality.

However, in some aspects the SSS functionality may be needed, used, or otherwise supported for the data communications between the UE 205 and the UPF 240 of the 3GPP core network via the non-3GPP access (e.g., via the IP network 250). Based on support for such functionality, the UE 205 may encapsulate some or all of the data communications using different encapsulation types. For example, the UE 205 may use a type of encapsulation to encapsulate some or all of the data communications. As one example, the UE 205 may use either an MPQUIC-based encapsulation or a MPTCP encapsulation to encapsulate the data communications. For example, the MP-TPC entity 210 may encapsulate the data communications that are recovered by the MP-TPC entity 260 of the UPF 240. As another example, the H3/MP-QUIC entity 215 may encapsulate the data communications that are recovered by the H3/MP-QUIC entity 265 of the UPF 240. In some aspects, the UE 205 may use the MPQUIC-based encapsulation or the MPTCP-based encapsulation for data communications that include IP-based communications. In some aspects, the UE 205 may use the MPQUIC-based encapsulation or the MPTCP-based encapsulation for data communications that include IMR or VoWiFi communications. For example, the UE 205 may use the MPQUIC-based encapsulation or the MPTCP-based encapsulation to support such communication types when the SSS functionality is needed or otherwise being supported.

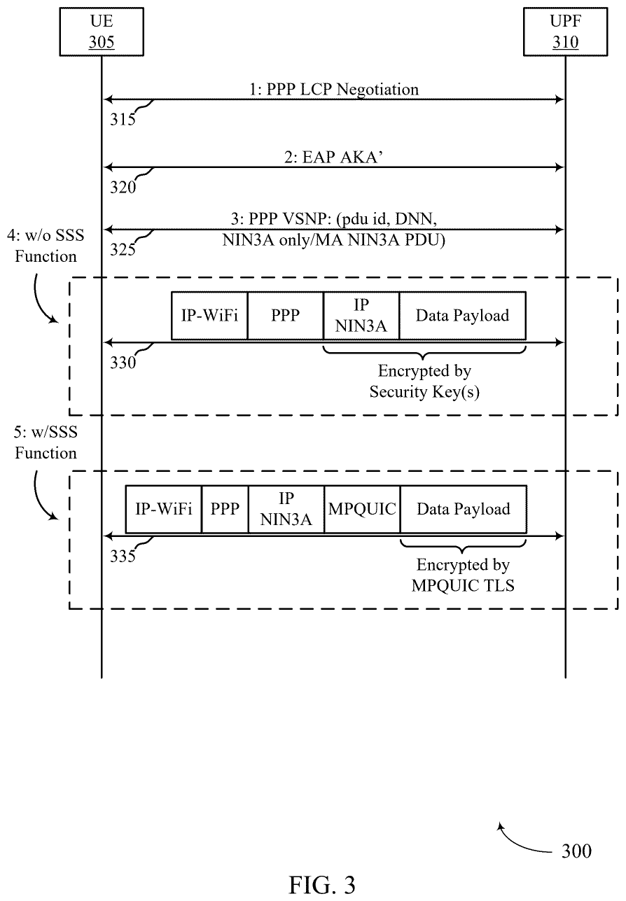

FIG. 3 shows an example of a swim diagram 300 that supports non-integrated access PDU session management in accordance with one or more aspects of the present disclosure. Swim diagram 300 may implement aspects of wireless communications system 100 or wireless communications system 200. Aspects of swim diagram 300 may be implemented at or implemented by a UE 305 and a UPF 310, which may be examples of the corresponding devices described herein. In some aspects, the UE 305 may also be referred to more generically as a network entity. The UPF 310 may be a part of a 3GPP core network (e.g., a cellular-based core network) that is used for performing data communications with the UE 305 via a non-cellular network.

At 315, the UE 305 and the UPF 310 may establish a secure tunnel via a first RAT. The first RAT may include a non-cellular RAT, such as a NIN3A-only access established via a non-3GPP access or link. This may include the UE 305 perform UPF discovery to identify or otherwise determine the UPF 310 of the 3GPP core network. In this example, the UE 305 and the UPF 310 may use a point-to-point-link control protocol (PTP-LCP) to establish the secure tunnel. For example, the UE 305 and the UPF 310 may perform a PTP-LCP negotiation to establish the secure tunnel via the non-3GPP access. However, in other examples the UE 305 and the UPF 310 may use a point-to-point tunneling protocol (PPTP) or a layer two tunneling protocol (L2TP) to establish the secure tunnel. Accordingly, this may include PPP-LCP establishment between the UE 305 and the UPF 310.

At 320, the UE 305 and the UPF 310 may perform, via the secure tunnel, an authentication and key establishment procedure to obtain a key (e.g., a security key). For example, this may include a mutual authentication and key exchange being performed using EAP-AKA over the PPP (e.g., over the secure tunnel established using the PPP-LCP).

At 325, the UE 305 and the UPF 310 may establish PDU session(s). For example, the UE 305 and the UPF 310 may establish the PDU session(s) using PPP VSNCP with some fields being used to indicate the PDU session identifier, the DNN name, and other information. In some aspects, the PDU session(s) may include a stand-alone or MA-NIN3A PDU session(s) that are differentiated within the PPP VSNCP fields. For example, the PTP-VSNCP IP header-level encapsulation where field(s) in the PTP-VSNCP IP header are used to carry or otherwise convey information that is used to differentiate the PDU sessions (e.g., such as the PDU session identifier, the DNN, or other identifying information for the PDU sessions).

At 330, the UE 305 may use the security key established at 320 to communicate data communications with the core network via the UPF 310 and the PDU session(s). In some aspects, the PDU session(s) may be conventional or normal PDU sessions being established and used for IMS VoWiFi traffic without the need for MPQUIC or MPTCP encapsulation. This may include data transfer after encryption using the key(s) (e.g., the security key(s) established at 320) and over the PPP-VSNP secure tunnel. For example, the data communications may be encapsulated using a IP NIN3A based encapsulation, such as the IP header-level encapsulation that are encrypted using the security key(s). The data communications may further include a PPP header as well as an IP WiFi header used for traffic routing within the non-3GPP access. In some cases, the data communications may include IMS or VoWiFi communications or traffic being communicated over the secure tunnel. The data communications performed at 330 without the MPQUIC or MPTCP-based encapsulation may not support the SSS functionality. That is, the encapsulation of the data payload using the IP NIN3A header (rather than MPQUIC or MPTCP-based encapsulation) may provide for establishment and use of the PDU sessions for the data communications but without the overhead associated with the MPQUIC or MPTCP-based encapsulation.

At 335, the UE 305 perform data communications with the UPF 310 where the SSS functionality has been adopted for the PDU session(s). For example, for internet PDU traffic where the SSS functionality is needed (e.g., MA-NIN3A PDU session(s)), the UE 305 may use the MPQUIC or MPTCP-based encapsulation. In this example, there is no need for more IP header encapsulation nor translation. The data communications are sent over the PPP-VSNP. In the case of the MA-NIN3A PDU session using the MPQUIC-based encapsulation, there may be no need for encryption at the PPP-VSNP level as the encryption will be provided using the TLS on MPQUIC. That is, the data payload corresponding to the data communications may be encrypted using the MPQUIC TLS.

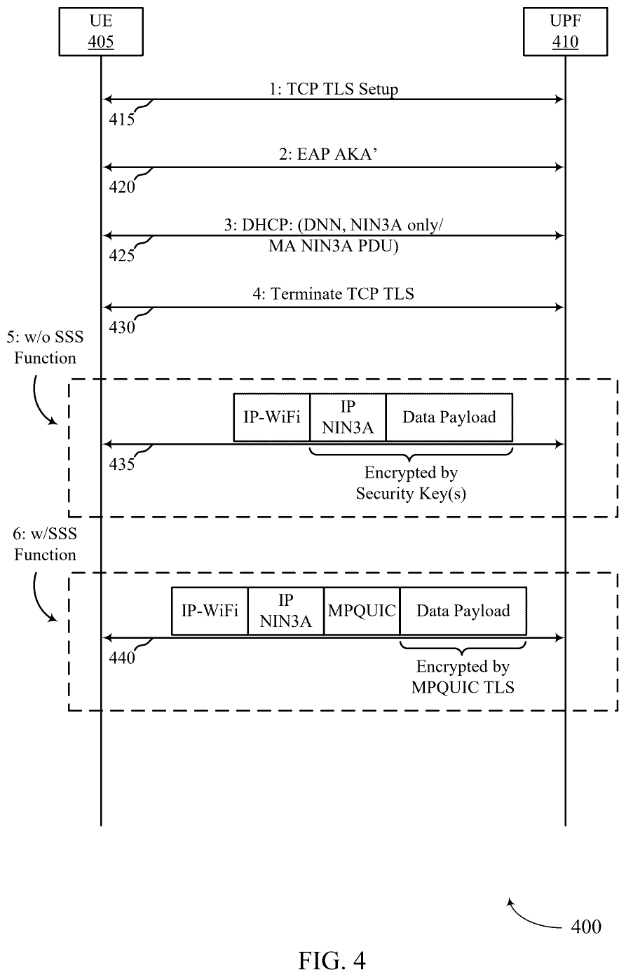

FIG. 4 shows an example of a swim diagram 400 that supports non-integrated access PDU session management in accordance with one or more aspects of the present disclosure. Swim diagram 400 may implement aspects of wireless communications system 100 or wireless communications system 200 or aspect of swim diagram 300. Aspects of swim diagram 400 may be implemented at or implemented by a UE 405 and a UPF 410, which may be examples of the corresponding devices described herein. In some aspects, the UE 405 may also be referred to more generically as a network entity. The UPF 410 may be a part of a 3GPP core network (e.g., a cellular-based core network) that is used for performing data communications with the UE 405 via a non-cellular network.

At 415, the UE 305 and the UPF 310 may establish a secure tunnel via a first RAT. The first RAT may include a non-cellular RAT, such as a NIN3A-only access established via a non-3GPP access or link. This may include the UE 405 perform UPF discovery to identify or otherwise determine the UPF 410 of the 3GPP core network. In this example, the UE 405 and the UPF 410 may use a TCP connection using TLS protocol establishment between the UE 405 and the UPF 410 to establish the secure tunnel. For example, the UE 405 and the UPF 410 may establish the TCP connection using the TLS protocol established for the secure tunnel.

At 420, the UE 405 and the UPF 410 may perform, via the secure tunnel, an authentication and key establishment procedure to obtain a key (e.g., a security key). For example, this may include a mutual authentication and key exchange being performed using EAP-AKA over the TCP-TLS (e.g., over the secure tunnel established using the TCP-TLS).

At 425, the UE 405 and the UPF 410 may establish PDU session(s). For example, the UE 405 and the UPF 410 may establish the PDU session(s) using a DHCP protocol. The DHCP protocol may include a DHCP discover message being exchanged with some fields being used to indicate the DNN name, and other information used to identify the PDU session(s). In some aspects, the PDU session(s) may include a stand-alone or MA-NIN3A PDU session(s) that are differentiated within the DHCP discover message field(s). This, the PDU session(s) may be established using the DHCP-DISCOVER with customized options used to indicate the DNN name. The PDU session(s) may be the stand-alone or MA-NIN3A PDU session(s) that are differentiated within the DHCP-DISCOVER field(s).

At 430, the UE 405 and the UPF 410 may terminate the TCP-TLS session established using the TCP-TLS protocol upon establishment of the PDU session(s). That is, the TCP-TLS protocol may be terminated as it is not needed for performing data communications using the PDU session(s).

At 435, the UE 405 may use the security key established at 420 to communicate data communications with the core network via the UPF 410 and the PDU session(s). In some aspects, the PDU session(s) may be conventional or normal PDU sessions being established and used for IMS VoWiFi traffic without the need for MPQUIC or MPTCP encapsulation. This may include data transfer after encryption using the key(s) (e.g., the security key(s) established at 420) and over the pure IP tunnel. At the UPF 410 and the UE 405, the differentiation of packets for different PDU sessions may be because the inner IP addressed obtained at 425 is different for different PDU sessions. For example, the data communications may be encapsulated using an IP NIN3A based encapsulation, such as the IP header-level encapsulation that are encrypted using the security key(s). The data communications may further include an IP WiFi header used for traffic routing within the non-3GPP access. In some cases, the data communications may include IMS or VoWiFi communications or traffic being communicated over the secure tunnel. The data communications performed at 435 without the MPQUIC or MPTCP-based encapsulation may not support the SSS functionality. That is, the encapsulation of the data payload using the IP NIN3A header (rather than MPQUIC or MPTCP-based encapsulation) may provide for establishment and use of the PDU sessions for the data communications but without the overhead associated with the MPQUIC or MPTCP-based encapsulation.

At 440, the UE 405 perform data communications with the UPF 410 where the SSS functionality has been adopted for the PDU session(s). For example, for internet PDU traffic where the SSS functionality is needed (e.g., MA-NIN3A PDU session(s)), the UE 405 may use the MPQUIC or MPTCP-based encapsulation. In this example, there is no need for more IP header encapsulation nor translation. The data communications are sent over the IP tunnel. In the case of the MA-NIN3A PDU session using the MPQUIC-based encapsulation, there may be no need for encryption at the entire IP tunnel as the encryption will be provided using the TLS on MPQUIC. That is, the data payload corresponding to the data communications may be encrypted using the MPQUIC TLS. The encrypted data may be sent inside the IP tunnel as at 435.

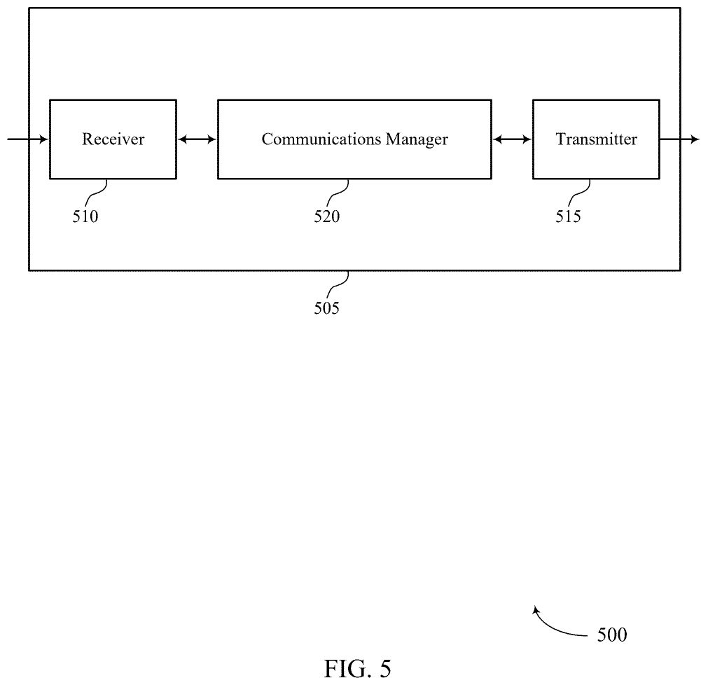

FIG. 5 shows a block diagram 500 of a device 505 that supports non-integrated access PDU session management in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to non-integrated access PDU session management). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to non-integrated access PDU session management). In some aspects, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of non-integrated access PDU session management as described herein. For example, the communications manager 520, the receiver 510, the transmitter 515, or various combinations or components thereof may be capable of performing one or more of the functions described herein.

In some aspects, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some aspects, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some aspects, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications performed in accordance with examples as disclosed herein. For example, the communications manager 520 is capable of, configured to, or operable to support a means for establishing, via a first RAT, a secure tunnel between the network entity and a UPF of a core network associated with a second RAT that is different from the first RAT. The communications manager 520 is capable of, configured to, or operable to support a means for performing, via the secure tunnel, an authentication and key establishment procedure with the UPF to obtain a key. The communications manager 520 is capable of, configured to, or operable to support a means for establishing one or more PDU sessions with the UPF. The communications manager 520 is capable of, configured to, or operable to support a means for communicating, using the key, data communications with the core network via the UPF and via the one or more PDU sessions.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for data communications between a UE and a 3GPP core network UPF via a non-3GPP access that flexibly provides the data communications without MPQUIC or MPTCP-based encapsulation when SSS functionality is not needed. This NIN3A-only approach reduces system overhead for IMS or VoWiFi traffic and support IP-based traffic when the SSS functionality is needed.

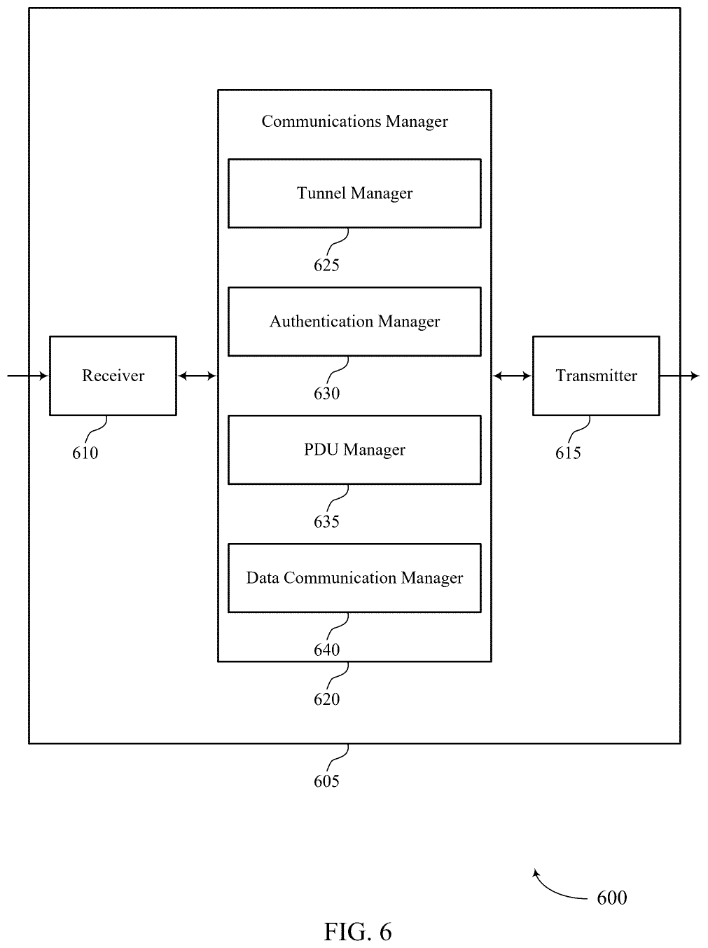

FIG. 6 shows a block diagram 600 of a device 605 that supports non-integrated access PDU session management in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to non-integrated access PDU session management). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to non-integrated access PDU session management). In some aspects, the transmitter 615 may be co-located with a receiver 610 in a transceiver module. The transmitter 615 may utilize a single antenna or a set of multiple antennas.

The device 605, or various components thereof, may be an example of means for performing various aspects of non-integrated access PDU session management as described herein. For example, the communications manager 620 may include a tunnel manager 625, an authentication manager 630, a PDU manager 635, a data communication manager 640, or any combination thereof. The communications manager 620 may be an example of aspects of a communications manager 520 as described herein. In some aspects, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications performed in accordance with examples as disclosed herein. The tunnel manager 625 is capable of, configured to, or operable to support a means for establishing, via a first RAT, a secure tunnel between the network entity and a UPF of a core network associated with a second RAT that is different from the first RAT. The authentication manager 630 is capable of, configured to, or operable to support a means for performing, via the secure tunnel, an authentication and key establishment procedure with the UPF to obtain a key. The PDU manager 635 is capable of, configured to, or operable to support a means for establishing one or more PDU sessions with the UPF. The data communication manager 640 is capable of, configured to, or operable to support a means for communicating, using the key, data communications with the core network via the UPF and via the one or more PDU sessions.

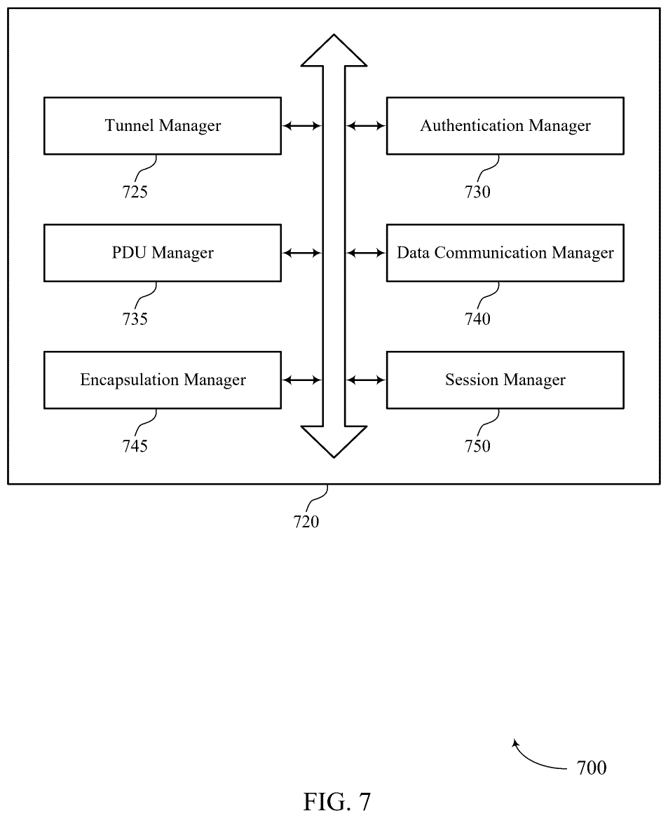

FIG. 7 shows a block diagram 700 of a communications manager 720 that supports non-integrated access PDU session management in accordance with one or more aspects of the present disclosure. The communications manager 720 may be an example of aspects of a communications manager 520, a communications manager 620, or both, as described herein. The communications manager 720, or various components thereof, may be an example of means for performing various aspects of non-integrated access PDU session management as described herein. For example, the communications manager 720 may include a tunnel manager 725, an authentication manager 730, a PDU manager 735, a data communication manager 740, an encapsulation manager 745, a session manager 750, or any combination thereof. Each of these components, or components or subcomponents thereof (e.g., one or more processors, one or more memories), may communicate, directly or indirectly, with one another (e.g., via one or more buses).

The communications manager 720 may support wireless communications performed in accordance with examples as disclosed herein. The tunnel manager 725 is capable of, configured to, or operable to support a means for establishing, via a first RAT, a secure tunnel between the network entity and a UPF of a core network associated with a second RAT that is different from the first RAT. The authentication manager 730 is capable of, configured to, or operable to support a means for performing, via the secure tunnel, an authentication and key establishment procedure with the UPF to obtain a key. The PDU manager 735 is capable of, configured to, or operable to support a means for establishing one or more PDU sessions with the UPF. The data communication manager 740 is capable of, configured to, or operable to support a means for communicating, using the key, data communications with the core network via the UPF and via the one or more PDU sessions.

In some aspects, the encapsulation manager 745 is capable of, configured to, or operable to support a means for encapsulating, based on support for functionality associated with the one or more PDU sessions, at least one data communication of the data communications, where the functionality includes a steering functionality, a switching functionality, or a splitting functionality.

In some aspects, encapsulating the data communications includes encapsulating the data communications using a type of encapsulation. In some aspects, the type of encapsulation includes either a MPQUIC-based encapsulation or a MPTCP-based encapsulation.

In some aspects, encapsulating the data communications includes encapsulating the data communications using a type of encapsulation. In some aspects, the type of encapsulation includes either a MPQUIC-based encapsulation or a MPTCP-based encapsulation. In some aspects, the data communications include IP-based communications using either the MPQUIC-based encapsulation or the MPTCP-based encapsulation.

In some aspects, the encapsulation manager 745 is capable of, configured to, or operable to support a means for encapsulating, based on non-support for a functionality associated with the one or more PDU sessions, at least one data communication of the data communications, where the functionality includes a steering functionality, a switching functionality, or a splitting functionality.

In some aspects, encapsulating the data communications includes encapsulating the data communications using a type of encapsulation. In some aspects, the type of encapsulation includes a PTP-VSNP IP header-level encapsulation. In some aspects, one or more fields associated with a PTP-VSNP IP header used in the PTP-VSNP IP header-level encapsulation indicate at least one of a PDU session identifier, a DNN, or identify the one or more PDU sessions. In some aspects, encapsulating the data communications includes encapsulating the data communications using a type of encapsulation. In some aspects, the type of encapsulation includes an IP header-level encapsulation. In some aspects, the data communications include IMS or VoWiFi communications.

In some aspects, encapsulating the data communications includes encapsulating the data communications using a type of encapsulation. In some aspects, the type of encapsulation excludes a MPQUIC-based encapsulation and a MPTCP-based encapsulation. In some aspects, establishing the secure tunnel includes establishing the secure tunnel using a PTP-LCP. In some aspects, the first RAT includes a non-cellular RAT and the second RAT includes a cellular RAT. In some aspects, the secure tunnel is associated with a non-integrated non-3GPP access PDU session management procedure. In some aspects, establishing the secure tunnel includes establishing the secure tunnel using a type of protocol. In some aspects, the type of protocol includes a TCP-TLS protocol.

In some aspects, the session manager 750 is capable of, configured to, or operable to support a means for terminating a TCP-TLS session established using the TCP-TLS protocol upon establishment of the one or more PDU sessions. In some aspects, the one or more PDU sessions are in accordance with a DHCP discover message. In some aspects, the DHCP discover message identifies a DNN. In some aspects, the DHCP discover message identifies the one or more PDU sessions.

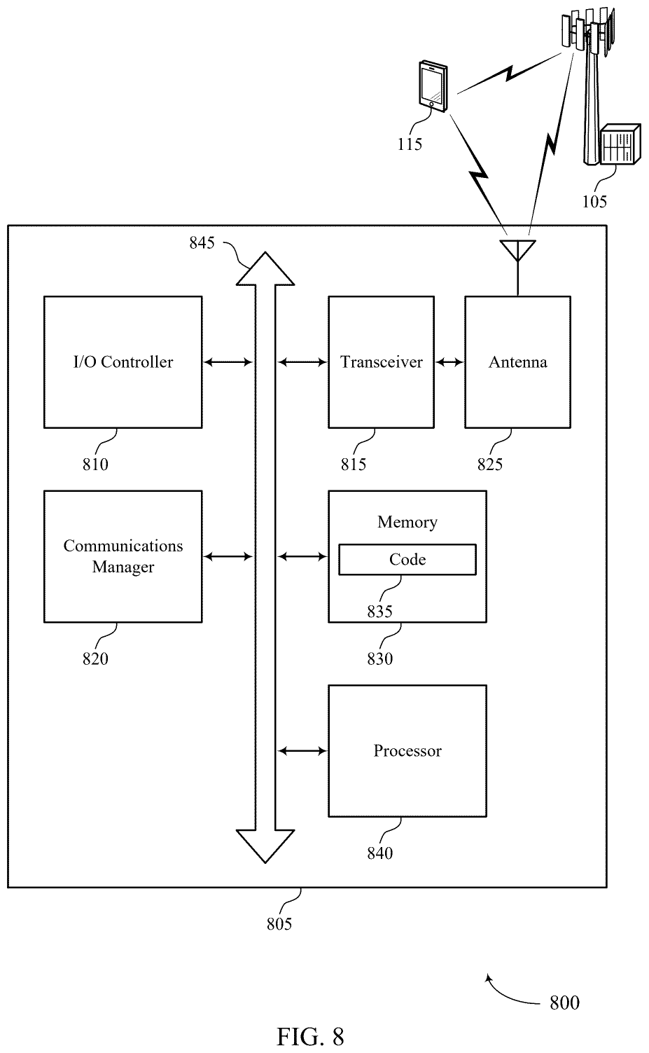

FIG. 8 shows a diagram of a system 800 including a device 805 that supports non-integrated access PDU session management in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting non-integrated access PDU session management). For example, the device 805 or a component of the device 805 may include at least one processor 840 and at least one memory 830 coupled with or to the at least one processor 840, the at least one processor 840 and the at least one memory 830 configured to perform various functions described herein.

In some aspects, the at least one processor 840 may include multiple processors and the at least one memory 830 may include multiple memories. One or more of the multiple processors may be coupled with one or more of the multiple memories, which may, individually or collectively, be configured to perform various functions described herein. In some aspects, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications performed in accordance with examples as disclosed herein. For example, the communications manager 820 is capable of, configured to, or operable to support a means for establishing, via a first RAT, a secure tunnel between the network entity and a UPF of a core network associated with a second RAT that is different from the first RAT. The communications manager 820 is capable of, configured to, or operable to support a means for performing, via the secure tunnel, an authentication and key establishment procedure with the UPF to obtain a key. The communications manager 820 is capable of, configured to, or operable to support a means for establishing one or more PDU sessions with the UPF. The communications manager 820 is capable of, configured to, or operable to support a means for communicating, using the key, data communications with the core network via the UPF and via the one or more PDU sessions.

By including or configuring the communications manager 820 in accordance with examples as described herein, the device 805 may support techniques for data communications between a UE and a 3GPP core network UPF via a non-3GPP access that flexibly provides the data communications without MPQUIC or MPTCP-based encapsulation when SSS functionality is not needed. This NIN3A-only approach reduces system overhead for IMS or VoWiFi traffic and support IP-based traffic when the SSS functionality is needed.

In some aspects, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some aspects, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of non-integrated access PDU session management as described herein, or the at least one processor 840 and the at least one memory 830 may be otherwise configured to, individually or collectively, perform or support such operations.

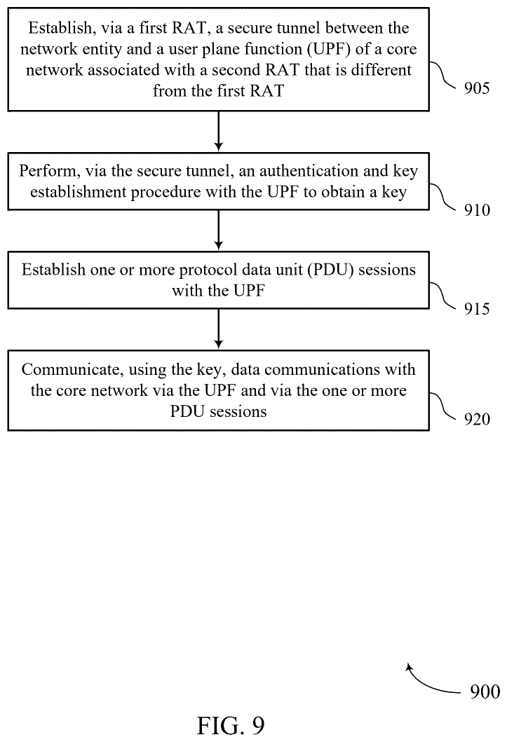

FIG. 9 shows a flowchart illustrating a method 900 that supports non-integrated access PDU session management in accordance with one or more aspects of the present disclosure. The operations of the method 900 may be implemented by a UE or its components as described herein. For example, the operations of the method 900 may be performed by a UE 115 as described with reference to FIGS. 1 through 8. In some aspects, a UE may execute a set of instructions to control the functional elements of the UE to perform the described functions. Additionally, or alternatively, the UE may perform aspects of the described functions using special-purpose hardware.

At 905, the method may include establishing, via a first RAT, a secure tunnel between the network entity and a UPF of a core network associated with a second RAT that is different from the first RAT. The operations of 905 may be performed in accordance with examples as disclosed herein. In some aspects, aspects of the operations of 905 may be performed by a tunnel manager 725 as described with reference to FIG. 7.

At 910, the method may include performing, via the secure tunnel, an authentication and key establishment procedure with the UPF to obtain a key. The operations of 910 may be performed in accordance with examples as disclosed herein. In some aspects, aspects of the operations of 910 may be performed by an authentication manager 730 as described with reference to FIG. 7.

At 915, the method may include establishing one or more PDU sessions with the UPF. The operations of 915 may be performed in accordance with examples as disclosed herein. In some aspects, aspects of the operations of 915 may be performed by a PDU manager 735 as described with reference to FIG. 7.

At 920, the method may include communicating, using the key, data communications with the core network via the UPF and via the one or more PDU sessions. The operations of 920 may be performed in accordance with examples as disclosed herein. In some aspects, aspects of the operations of 920 may be performed by a data communication manager 740 as described with reference to FIG. 7.

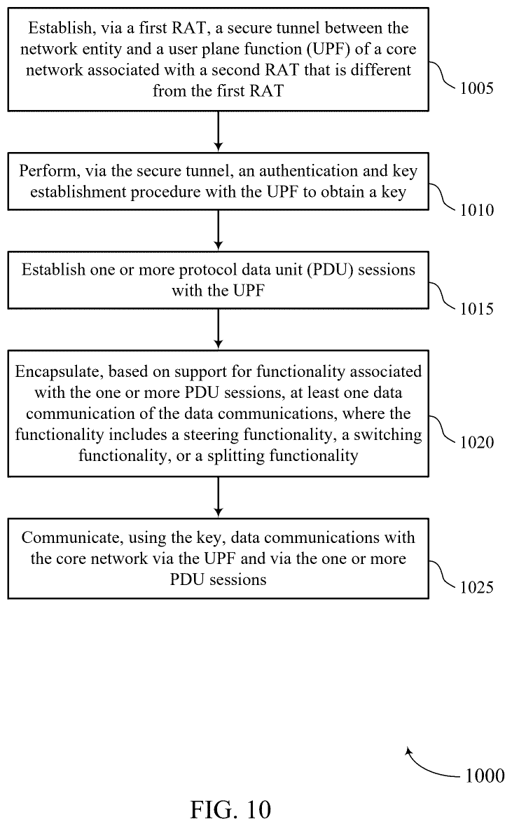

FIG. 10 shows a flowchart illustrating a method 1000 that supports non-integrated access PDU session management in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some aspects, a UE may execute a set of instructions to control the functional elements of the UE to perform the described functions. Additionally, or alternatively, the UE may perform aspects of the described functions using special-purpose hardware.

At 1005, the method may include establishing, via a first RAT, a secure tunnel between the network entity and a UPF of a core network associated with a second RAT that is different from the first RAT. The operations of 1005 may be performed in accordance with examples as disclosed herein. In some aspects, aspects of the operations of 1005 may be performed by a tunnel manager 725 as described with reference to FIG. 7.

At 1010, the method may include performing, via the secure tunnel, an authentication and key establishment procedure with the UPF to obtain a key. The operations of 1010 may be performed in accordance with examples as disclosed herein. In some aspects, aspects of the operations of 1010 may be performed by an authentication manager 730 as described with reference to FIG. 7.

At 1015, the method may include establishing one or more PDU sessions with the UPF. The operations of 1015 may be performed in accordance with examples as disclosed herein. In some aspects, aspects of the operations of 1015 may be performed by a PDU manager 735 as described with reference to FIG. 7.

At 1020, the method may include encapsulating, based on support for functionality associated with the one or more PDU sessions, at least one data communication of the data communications, where the functionality includes a steering functionality, a switching functionality, or a splitting functionality. The operations of 1020 may be performed in accordance with examples as disclosed herein. In some aspects, aspects of the operations of 1020 may be performed by an encapsulation manager 745 as described with reference to FIG. 7.

At 1025, the method may include communicating, using the key, data communications with the core network via the UPF and via the one or more PDU sessions. The operations of 1025 may be performed in accordance with examples as disclosed herein. In some aspects, aspects of the operations of 1025 may be performed by a data communication manager 740 as described with reference to FIG. 7.

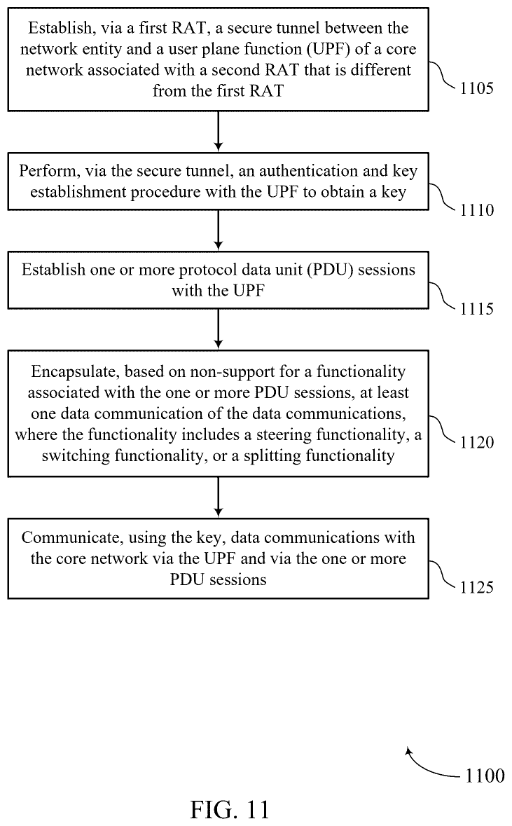

FIG. 11 shows a flowchart illustrating a method 1100 that supports non-integrated access PDU session management in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some aspects, a UE may execute a set of instructions to control the functional elements of the UE to perform the described functions. Additionally, or alternatively, the UE may perform aspects of the described functions using special-purpose hardware.

At 1105, the method may include establishing, via a first RAT, a secure tunnel between the network entity and a UPF of a core network associated with a second RAT that is different from the first RAT. The operations of 1105 may be performed in accordance with examples as disclosed herein. In some aspects, aspects of the operations of 1105 may be performed by a tunnel manager 725 as described with reference to FIG. 7.

At 1110, the method may include performing, via the secure tunnel, an authentication and key establishment procedure with the UPF to obtain a key. The operations of 1110 may be performed in accordance with examples as disclosed herein. In some aspects, aspects of the operations of 1110 may be performed by an authentication manager 730 as described with reference to FIG. 7.

At 1115, the method may include establishing one or more PDU sessions with the UPF. The operations of 1115 may be performed in accordance with examples as disclosed herein. In some aspects, aspects of the operations of 1115 may be performed by a PDU manager 735 as described with reference to FIG. 7.

At 1120, the method may include encapsulating, based on non-support for a functionality associated with the one or more PDU sessions, at least one data communication of the data communications, where the functionality includes a steering functionality, a switching functionality, or a splitting functionality. The operations of 1120 may be performed in accordance with examples as disclosed herein. In some aspects, aspects of the operations of 1120 may be performed by an encapsulation manager 745 as described with reference to FIG. 7.

At 1125, the method may include communicating, using the key, data communications with the core network via the UPF and via the one or more PDU sessions. The operations of 1125 may be performed in accordance with examples as disclosed herein. In some aspects, aspects of the operations of 1125 may be performed by a data communication manager 740 as described with reference to FIG. 7.

The following provides an overview of aspects of the present disclosure:
Aspect 1: A method for wireless communications performed by a network entity, comprising: establishing, via a first RAT, a secure tunnel between the network entity and a UPF of a core network associated with a second RAT that is different from the first RAT; performing, via the secure tunnel, an authentication and key establishment procedure with the UPF to obtain a key; establishing one or more PDU sessions with the UPF; and communicating, using the key, data communications with the core network via the UPF and via the one or more PDU sessions.
Aspect 2: The method of aspect 1, further comprising: encapsulating, based on support for functionality associated with the one or more PDU sessions, at least one data communication of the data communications, wherein the functionality includes a steering functionality, a switching functionality, or a splitting functionality.
Aspect 3: The method of aspect 2, wherein encapsulating the data communications comprises encapsulating the data communications using a type of encapsulation, the type of encapsulation includes either a MPQUIC-based encapsulation or a MPTCP-based encapsulation.
Aspect 4: The method of any of aspects 1 through 3, wherein encapsulating the data communications comprises encapsulating the data communications using a type of encapsulation, the type of encapsulation includes either a MPQUIC-based encapsulation or a MPTCP-based encapsulation, and the data communications comprise IP-based communications using either the MPQUIC-based encapsulation or the MPTCP-based encapsulation.
Aspect 5: The method of any of aspects 1 through 4, further comprising: encapsulating, based on non-support for a functionality associated with the one or more PDU sessions, at least one data communication of the data communications, wherein the functionality includes a steering functionality, a switching functionality, or a splitting functionality.
Aspect 6: The method of any of aspects 1 through 5, wherein encapsulating the data communications comprises encapsulating the data communications using a type of encapsulation, the type of encapsulation includes a PTP-VSNP IP header-level encapsulation.
Aspect 7: The method of aspect 6, wherein one or more fields associated with a PTP-VSNP IP header used in the PTP-VSNP IP header-level encapsulation indicate at least one of a PDU session identifier, a DNN, or identify the one or more PDU sessions.
Aspect 8: The method of any of aspects 1 through 7, wherein encapsulating the data communications comprises encapsulating the data communications using a type of encapsulation, the type of encapsulation includes an IP header-level encapsulation, and the data communications comprise IMS or VoWiFi communications.
Aspect 9: The method of aspect 8, wherein encapsulating the data communications comprises encapsulating the data communications using a type of encapsulation, the type of encapsulation excludes a MPQUIC-based encapsulation and a MPTCP-based encapsulation.
Aspect 10: The method of any of aspects 1 through 9, wherein establishing the secure tunnel comprises establishing the secure tunnel using a PTP-LCP.
Aspect 11: The method of any of aspects 1 through 10, wherein the first RAT comprises a non-cellular RAT and the second RAT comprises a cellular RAT.
Aspect 12: The method of any of aspects 1 through 11, wherein the secure tunnel is associated with a non-integrated non-3GPP access PDU session management procedure.
Aspect 13: The method of any of aspects 1 through 12, wherein establishing the secure tunnel comprises establishing the secure tunnel using a type of protocol, the type of protocol includes a TCP-TLS protocol.
Aspect 14: The method of aspect 13, further comprising: terminating a TCP-TLS session established using the TCP-TLS protocol upon establishment of the one or more PDU sessions.
Aspect 15: The method of any of aspects 1 through 14, wherein the one or more PDU sessions are in accordance with a DHCP discover message, the DHCP discover message identifies a DNN, and the DHCP discover message identifies the one or more PDU sessions.
Aspect 16: A network entity for wireless communications performed, comprising a processing system configured to perform a method of any of aspects 1 through 15.
Aspect 17: A network entity for wireless communications performed, comprising at least one means for performing a method of any of aspects 1 through 15.
Aspect 18: A non-transitory computer-readable medium having code for wireless communications stored thereon that, when executed by a network entity, causes the network entity to perform a method of any of aspects 1 through 15.

The methods described herein describe possible implementations, and the operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communications, comprising:
a processing system configured to:
establish, via a first radio access technology (RAT), a secure tunnel between the network entity and a user plane function (UPF) of a core network associated with a second RAT that is different from the first RAT;
perform, via the secure tunnel, an authentication and key establishment procedure with the UPF to obtain a key;
establish one or more protocol data unit (PDU) sessions with the UPF; and
communicate, using the key, data communications with the core network via the UPF and via the one or more PDU sessions.

2. The network entity of claim 1, wherein, to encapsulate the data communications, the processing system is configured to encapsulate, based on support for functionality associated with the one or more PDU sessions, at least one data communication of the data communications, wherein the functionality includes a steering functionality, a switching functionality, or a splitting functionality.

3. The network entity of claim 2, wherein, to encapsulate the data communications, the processing system is configured to encapsulate the data communications using a type of encapsulation, wherein the type of encapsulation includes either a multi-path-quick user datagram protocol (UDP) internet communication (MPQUIC)-based encapsulation or a multi-path transport control protocol (MPTCP)-based encapsulation.

4. The network entity of claim 1, wherein, to encapsulate the data communications, the processing system is configured to encapsulate the data communications using a type of encapsulation, wherein the type of encapsulation includes either a multi-path-quick user datagram protocol (UDP) internet communication (MPQUIC)-based encapsulation or a multi-path transport control protocol (MPTCP)-based encapsulation, and wherein the data communications comprise internet protocol (IP)-based communications using either the MPQUIC-based encapsulation or the MPTCP-based encapsulation.

5. The network entity of claim 1, wherein the processing system is configured to:
encapsulate, based on non-support for a functionality associated with the one or more PDU sessions, at least one data communication of the data communications, wherein the functionality includes a steering functionality, a switching functionality, or a splitting functionality.

6. The network entity of claim 1, wherein, to encapsulate the data communications, the processing system is configured to encapsulate the data communications using a type of encapsulation, and wherein the type of encapsulation includes a point-to-point (PTP)-vendor specific network protocol (VSNP) internet protocol (IP) header-level encapsulation.

7. The network entity of claim 6, wherein one or more fields associated with a PTP-VSNP IP header used in the PTP-VSNP IP header-level encapsulation indicate at least one of a PDU session identifier, a data network name (DNN), or identify the one or more PDU sessions.

8. The network entity of claim 1, wherein, to encapsulate the data communications, the processing system is configured to encapsulate the data communications using a type of encapsulation, wherein the type of encapsulation includes an internet protocol (IP) header-level encapsulation, and wherein the data communications comprise internet messaging service (IMS) or voice-over WiFi (VoWiFi) communications.

9. The network entity of claim 8, wherein, to encapsulate the data communications, the processing system is configured to encapsulate the data communications using a type of encapsulation, and wherein the type of encapsulation excludes a multi-path-quick user datagram protocol (UDP) internet communication (MPQUIC)-based encapsulation and a multi-path transport control protocol (MPTCP)-based encapsulation.

10. The network entity of claim 1, wherein, to establish the secure tunnel, the processing system is configured to establish the secure tunnel using a point-to-point-link control protocol (PTP-LCP).

11. The network entity of claim 1, wherein the first RAT comprises a non-cellular RAT and the second RAT comprises a cellular RAT.

12. The network entity of claim 1, wherein the secure tunnel is associated with a non-integrated non-third generation partnership project (3GPP) access PDU session management procedure.

13. The network entity of claim 1, wherein, to establish the secure tunnel, the processing system is configured to establish the secure tunnel using a type of protocol, and wherein the type of protocol includes a transport control protocol (TCP)-transport layer security (TLS) protocol.

14. The network entity of claim 13, wherein the processing system is configured to:
terminate a TCP-TLS session established using the TCP-TLS protocol upon establishment of the one or more PDU sessions.

15. The network entity of claim 1, wherein the one or more PDU sessions are in accordance with a dynamic host configuration protocol (DHCP) discover message, wherein the DHCP discover message identifies a data network name (DNN), and wherein the DHCP discover message identifies the one or more PDU sessions.

16. A method for wireless communications performed by a network entity, comprising:
establishing, via a first radio access technology (RAT), a secure tunnel between the network entity and a user plane function (UPF) of a core network associated with a second RAT that is different from the first RAT;
performing, via the secure tunnel, an authentication and key establishment procedure with the UPF to obtain a key;
establishing one or more protocol data unit (PDU) sessions with the UPF; and
communicating, using the key, data communications with the core network via the UPF and via the one or more PDU sessions.

17. The method of claim 16, further comprising:
encapsulating, based on support for functionality associated with the one or more PDU sessions, at least one data communication of the data communications, wherein the functionality includes a steering functionality, a switching functionality, or a splitting functionality.

18. The method of claim 17, wherein encapsulating the data communications comprises encapsulating the data communications using a type of encapsulation, and wherein the type of encapsulation includes either a multi-path-quick user datagram protocol (UDP) internet communication (MPQUIC)-based encapsulation or a multi-path transport control protocol (MPTCP)-based encapsulation.

19. The method of claim 16, wherein encapsulating the data communications comprises encapsulating the data communications using a type of encapsulation, wherein the type of encapsulation includes either a multi-path-quick user datagram protocol (UDP) internet communication (MPQUIC)-based encapsulation or a multi-path transport control protocol (MPTCP)-based encapsulation, and wherein the data communications comprise internet protocol (IP)-based communications using either the MPQUIC-based encapsulation or the MPTCP-based encapsulation.

20. A non-transitory computer-readable medium having code for wireless communications stored thereon that, when executed by a network entity, causes the network entity to:
establish, via a first radio access technology (RAT), a secure tunnel between the network entity and a user plane function (UPF) of a core network associated with a second RAT that is different from the first RAT;
perform, via the secure tunnel, an authentication and key establishment procedure with the UPF to obtain a key;
establish one or more protocol data unit (PDU) sessions with the UPF; and
communicate, using the key, data communications with the core network via the UPF and via the one or more PDU sessions.
